(19) United States
(12) Patent Application Publication
(10) Pub. No.: US 2011/0001735 A1
(43) Pub. Date: Jan. 6, 2011

(54) ELECTRO-OPTICAL DEVICE, METHOD FOR DRIVING ELECTRO-OPTICAL DEVICE AND ELECTRONIC APPARATUS

(75) Inventor: Tomoyuki OKUYAMA, Chino-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/824,416

(22) Filed: Jun. 28, 2010

(30) Foreign Application Priority Data
Jul. 1, 2009 (JP) 2009-156818

(51) Int. Cl. G09G 5/00

(52) U.S. Cl. 345/204; 345/87

(57) ABSTRACT

An electro-optical device operates in a cycle of unit periods of time. Each of the unit periods of time includes a first time period, a second time period, and a third time period. The electro-optical device includes: scanning lines; data lines; potential lines; a driving section; and pixels, each of pixels including a pixel electrode. In the first time period of a certain unit period of time, the driving section writes a data potential that is in accordance with an image into the pixel electrode. In the second time period, the driving section writes a reset potential that makes a potential of the pixel electrode closer to a potential of the potential line. In the third time period, the driving section sequentially makes a transition of a potential of the potential lines from a first potential to a second potential.

### BACKGROUND

1. Technical Field

The present invention relates to an electro-optical device that uses an electro-optical material such as liquid crystal, a method for driving the electro-optical device, and an electronic apparatus.

2. Related Art

Liquid crystal is known as an electro-optical material whose optical characteristics change depending on electric energy. The transmission factor of liquid crystal changes as a voltage applied changes. The change in the transmission factor occurs due to a change in the orientation state of liquid crystal molecules depending on the voltage applied. As the characteristics of liquid crystal, its orientation state is less liable to return to an original state when a direct-current voltage is applied for a long period of time. In consideration of the above characteristics, an alternating-current driving method is generally used in a liquid crystal display device, which uses liquid crystal as its display medium. In the AC driving, the polarity of a voltage that is applied to liquid crystal elements, which constitute a kind of electro-optical elements, is reversed in an alternating manner. A liquid crystal display device is provided with a plurality of scanning lines, a plurality of data lines, and a plurality of pixels. A pixel is provided at an area corresponding to each of the intersections of the scanning lines and the data lines. Each of the plurality of pixels includes a liquid crystal element, which is made up of a pixel electrode, a counter electrode provided opposite to the pixel electrode, and liquid crystal that is sandwiched between the pixel electrode and the counter electrode. As a method for inverting a voltage that is applied to a liquid crystal element, a technique for reversing the polarity of a data potential, which is applied via a data line, with the potential of a counter electrode (hereinafter referred to as “counter electrode potential”) being fixed is known as disclosed in Japanese Patent No. 3918536. In the technique disclosed in the above patent document, the polarity of the data potential is reversed with respect to the counter electrode potential, which is the center of the reversal. Besides the above technique, a method of reversing the polarity of a counter electrode potential while using the center reference level of the amplitude of a data potential, and in addition, reversing the polarity of the data potential is known as disclosed in JP-A-2005-241741. In comparison with the technique in which the counter electrode potential is fixed, the technique in which the polarity of the counter electrode potential is reversed makes it possible to reduce the amplitude of the data potential by half.

However, when the technique disclosed in JP-A-2005-241741 is adopted, the reversal of the polarity of the counter electrode potential results in a change in the potential of a pixel electrode due to liquid crystal capacitance, where the amount of the change in the potential of the pixel electrode is equal to the amount of the change in the counter electrode potential. Therefore, in some cases, a voltage that is twice as large as the amplitude of a data potential is applied to a transistor that is provided between a data line and the pixel electrode. Therefore, it is necessary to increase the withstand voltage of the transistor, which makes it necessary to increase the channel length of the transistor. For higher definition of a display image, the shortening of the channel is indispensable. Therefore, a problem arises in that the withstand voltage of the transistor decreases due to the decreased channel length of the transistor.

### SUMMARY

An advantage of some aspects of the invention is to provide a technique that makes it possible to lower the withstand voltage of a transistor (switching element) provided in a pixel while displaying an image in high quality, and in addition, improve reliability.

An electro-optical device according to a first aspect of the invention operates in a cycle of unit periods of time, each of the unit periods of time including a first time period, a second time period, and a third time period, the electro-optical device including: a plurality of scanning lines; a plurality of data lines; a plurality of potential lines; a driving section; and a plurality of pixels that are provided at positions corresponding to respective intersections of the scanning lines and the data lines, each of the plurality of pixels including a pixel electrode, an electro-optical material that has optical characteristics that change depending on an electric field applied between the pixel electrode and the potential line, and a switching element that is provided between the pixel electrode and the data line, the switching element being controlled in such a manner that the switching element is put into either an ON state or an OFF state, a scanning signal that is supplied through the scanning line is used for controlling the switching element, wherein, in the first time period of a certain unit period of time, the driving section supplies scanning signals for putting the switching elements into the ON state through the plurality of scanning lines in a predetermined sequential order and writes a data potential that is in accordance with an image that is to be displayed into the pixel electrode of each of the pixels through the data line, in the second time period of the certain unit period of time, the driving section supplies scanning signals for putting the switching elements into the ON state through the plurality of scanning lines in a predetermined sequential order and writes, for one row at a time, a reset potential that approximates a potential of the pixel electrode to, makes a potential of the pixel electrode closer to, or makes a potential of the pixel electrode equal to, a potential of the potential line that extends on the row, and in the third time period of the certain unit period of time, the driving section sequentially selects the plurality of potential lines to cause a transition of a potential that is supplied through the selected potential line from one of two potentials, which are a first potential and a second potential, to the other.

In the operation of an electro-optical device according to the first aspect of the invention, in the second time period, a reset potential that approximates a potential of the pixel electrode to, makes a potential of the pixel electrode closer to, or makes a potential of the pixel electrode equal to, a potential of the potential line is written. Thereafter, the plurality of potential lines is selected sequentially for reversing the polarity thereof. Therefore, it is possible to lower the withstand voltage of a switching element. In addition, it is possible to shorten time required for polarity reversal. A driving method may be ordinary analog driving or sub-field driving.

It is preferable that the reset potential should be the same as the potential of the potential line. When the reset potential is the same as the potential of the potential line, it is possible to lower the withstand voltage of the switching element by a greater reduction. The size of a switching element can be decreased as the withstand voltage thereof decreases. Therefore, the preferred configuration of the invention described above is advantageous for displaying an image with high definition.

In an electro-optical device according to the first aspect of the invention, it is preferable that the first time period should be divided into a plurality of individual time periods (e.g., sub field time periods sf1 to sf11 that are disclosed in an embodiment below); and the driving section should supply scanning signals for putting the switching elements into the ON state through the plurality of scanning lines in a predetermined sequential order and select one of binary potential values as the data potential to write the selected potential into the pixel electrode of the pixel through the data line. With the preferred configuration of the invention described above, it is possible to display an image in a so-called sub-field driving scheme.

In an electro-optical device having the preferred configuration described above, it is preferable that the binary potential values should be the first potential and the second potential. By this means, it is possible to minimize the amplitude of a data potential. A data line is subjected to a capacitive load accompanied with parasitic capacitance. Since the amplitude of a data potential is minimized, the preferred configuration of the invention makes it possible to reduce power consumption.

In an electro-optical device according to the first aspect of the invention, it is preferable that the pixel electrodes and the potential lines should be formed on the same single substrate; and the electric field should be a horizontal electric field.

An electronic apparatus according to a second aspect of the invention is provided with an electro-optical device according to the first aspect of the invention. Examples of an electronic apparatus according to the second aspect of the invention are: a projector, a head-mount display device, an electronic viewfinder, a person computer, a mobile phone, and a personal digital assistant (PDA).

A third aspect of the invention is a method for driving an electro-optical device that operates in a cycle of unit periods of time. Each of the unit periods of time includes a first time period, a second time period, and a third time period. The electro-optical device includes a plurality of scanning lines, a plurality of data lines, a plurality of potential lines, and a plurality of pixels. The pixels are provided at positions corresponding to respective intersections of the scanning lines and the data lines. Each of the pixels includes a pixel electrode and an electro-optical material that has optical characteristics that change depending on an electric field applied between the pixel electrode and the potential line. The driving method according to the third aspect of the invention includes: in the first time period of a certain unit period of time, writing a potential that is in accordance with tone that is to be displayed into the pixel electrode of each of the plurality of pixels to be held in the pixel; in the second time period of the certain unit period of time, sequentially selecting the plurality of scanning lines to write, for one row at a time, a reset potential that approximates a potential of the pixel electrode to, makes a potential of the pixel electrode closer to, or makes a potential of the pixel electrode equal to, a potential of the potential line that extends on the row; and in the third time period of the certain unit period of time, sequentially selecting the plurality of potential lines to cause a transition of a potential that is supplied through the selected potential line from one of two potentials, which are a first potential and a second potential, to the other. In the method for driving an electro-optical device according to the third aspect of the invention, in the second time period, a reset potential that approximates a potential of the pixel electrode to, makes a potential of the pixel electrode closer to, or makes a potential of the pixel electrode equal to, a potential of the potential line is written. Thereafter, the plurality of potential lines is selected sequentially for reversing the polarity thereof. Therefore, it is possible to lower the withstand voltage of a switching element. In addition, it is possible to shorten time required for polarity reversal. It is preferable that the reset potential should be the same as the potential of the potential line.

### BRIEF DESCRIPTION OF THE DRAWINGS

The invention will be described with reference to the accompanying drawings, wherein like numbers reference like elements.

FIG. 1 is a block diagram that schematically illustrates an example of the overall configuration of an electro-optical device according to an exemplary embodiment of the invention.

FIG. 2 is a circuit diagram that schematically illustrates an example of the configuration of a pixel in an electro-optical device according to an exemplary embodiment of the invention.

FIG. 3 is a diagram that schematically illustrates an example of sub fields that make up one frame according to an exemplary embodiment of the invention.

FIG. 4 is a timing chart that schematically illustrates a relationship between scanning signals, potentials of pixel electrodes, and potential signals according to an exemplary embodiment of the invention.

FIG. 5 is a perspective view that schematically illustrates an example of the configuration of a personal computer, which is an example of an electronic apparatus to which an electro-optical device according to an exemplary embodiment of the invention is applied.

FIG. 6 is a perspective view that schematically illustrates an example of the configuration of a mobile phone, which is an example of an electronic apparatus to which an electro-optical device according to an exemplary embodiment of the invention is applied.

FIG. 7 is a perspective view that schematically illustrates an example of the configuration of a personal digital assistant (PDA), which is an example of an electronic apparatus to which an electro-optical device according to an exemplary embodiment of the invention is applied.

### DESCRIPTION OF EXEMPLARY EMBODIMENTS

### 1. Embodiment

An electro-optical device according to the present embodiment of the invention uses liquid crystal as an electro-optical material. An electro-optical device 1 includes a liquid crystal panel as its principal part. The liquid crystal panel is an example of an electro-optical panel according to an aspect of the invention. The liquid crystal panel is mainly made up of an element substrate, a counter substrate, and liquid crystal. The element substrate and the counter substrate are provided opposite to each other in such a manner that the electrode formation surface of the element substrate faces the electrode formation surface of the counter substrate. Thin film transistors (hereinafter abbreviated as TFT), which function as switching elements, are formed on the element substrate. The element substrate and the counter substrate are attached to each other with a predetermined gap space being formed therebetween. The liquid crystal is sandwiched at and sealed in the gap space between the element substrate and the counter substrate.

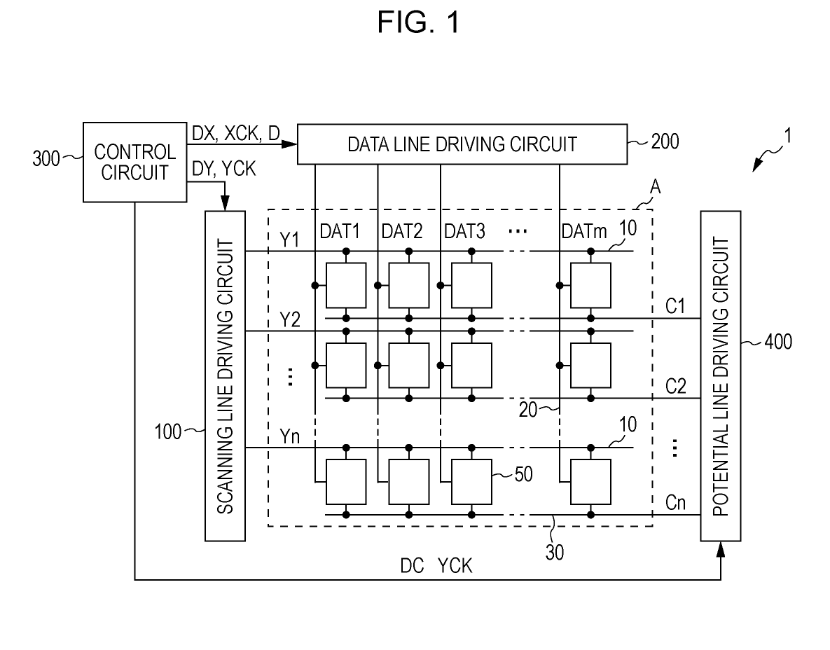

FIG. 1 is a block diagram that schematically illustrates an example of the overall configuration of the electro-optical device 1 according to an exemplary embodiment of the invention. The electro-optical device 1 includes a scanning line driving circuit 100, a data line driving circuit 200, a control circuit 300, a potential line driving circuit 400, and an image display area A. Among these components, the liquid crystal panel includes at least the image display area A. The scanning line driving circuit 100, the data line driving circuit 200, the control circuit 300, and the potential line driving circuit 400 may be built in the liquid crystal panel. Alternatively, these circuits may be provided as external circuitry.

An “n” number (n is a natural number that is not smaller than two) of scanning lines 10 and an “m” number (m is a natural number that is not smaller than two) of data lines 20 are provided in the image display area A. An n x m number of pixels 50 are provided at positions corresponding to the intersections of the scanning lines 10 and the data lines 20. In addition, an n number of potential lines 30 are provided in the image display area A. Light emitted from a backlight that is not shown in the drawing enters the pixels 50 as incident light to adjust the transmission factor of the pixels 50. By this means, it is possible to modulate light so as to realize tone display.

The control circuit 300 generates an X transfer start pulse DX, an X clock signal XCK, image data D, and the like and then supplies the pulse, the signal, the data, and the like to the data line driving circuit 200. The control circuit 300 generates a Y transfer start pulse DY and a Y clock signal YCK and then supplies the pulse and the signal to the scanning line driving circuit 100. In addition, the control circuit 300 generates a C transfer start pulse DC and the Y clock signal YCK and then supplies the pulse and the signal to the potential line driving circuit 400. The scanning line driving circuit 100 is provided with a shift register. The scanning line driving circuit 100 transfers the Y transfer start pulse DY in accordance with the Y clock signal YCK, thereby generating scanning signals Y1 to Yn for selecting the n number of scanning lines 10. The data line driving circuit 200 generates line sequential data potentials DAT1 to DATm on the basis of the dot sequential image data D. The potential line driving circuit 400 is provided with a shift register. The potential line driving circuit 400 divides the counts of shift pulses that are obtained by transferring the C transfer start pulse DC in accordance with the Y clock signal YCK to generate potential signals C1 to Cn.

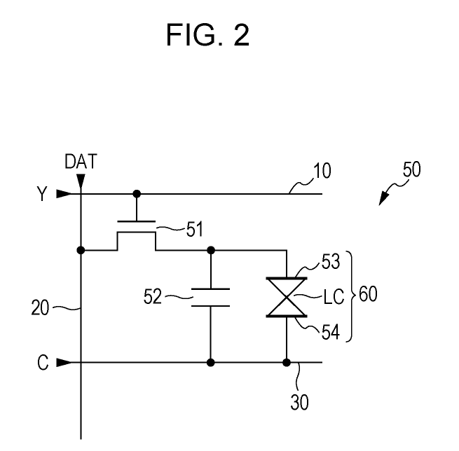

The electric configuration of the pixel 50 is illustrated in FIG. 2. The pixel 50 includes a liquid crystal element 60, a selection transistor 51, and a hold capacitor 52. The selection transistor 51 is provided between the data line 20 and the liquid crystal element 60. The liquid crystal element 60 is made up of a pixel electrode 53, an individual electrode 54, and liquid crystal LC that is provided between the pixel electrode 53 and the individual electrode 54. The pixel electrode 53 and the individual electrode 54 are formed on the element substrate. A horizontal electric field is applied to the liquid crystal LC. More specifically, the individual electrode 54 is formed as a part of the potential line 30.

The pixel 50 having the above configuration is operated as follows. When the scanning signal Y that is supplied via the scanning line 10 is set into an active state, the selection transistor 51 is turned ON. When the selection transistor 51 is ON, the data potential DAT is written into the liquid crystal element 60. When the scanning signal Y is set into an inactive state, the selection transistor 51 is turned OFF. When the selection transistor 51 is OFF, the data potential DAT that has been written into the liquid crystal element 60 is held. The hold capacitor 52 is provided between the pixel electrode 53 and the potential line 30. When the selection transistor 51 is actually operated, it is not put into a perfect OFF state. Therefore, a leak current that has a certain level is generated. Since the hold capacitor 52 is provided, it is possible to reduce the effects of the leak current to improve the holding characteristics of the data potential DAT.

In the present embodiment of the invention, the liquid crystal element 60 is set in a normally white mode. Therefore, the transmission factor of the liquid crystal element 60 changes toward a lighter side as the effective value of a difference voltage between the pixel electrode 53 and the individual electrode 54 decreases. In a state in which no voltage is applied, its color is almost white. In the present embodiment of the invention, either an ON voltage, which sets the difference voltage at a voltage that is not smaller than a saturation voltage, or an OFF voltage, which sets the difference voltage at a voltage that is not larger than a threshold voltage, is applied to the pixel electrode 53.

The transmission factor in the darkest state is defined as a relative transmission factor 0%. The transmission factor in the brightest state is defined as a relative transmission factor 100%. Among voltages that are applied to the liquid crystal element 60, a voltage whose relative transmission factor is 10% and a voltage whose relative transmission factor is 90% are defined as an optical threshold voltage and an optical saturation voltage, respectively. In a voltage modulation scheme (analog driving), it is designed that a voltage that is not larger than the optical saturation voltage should be applied to the liquid crystal LC when the liquid crystal element 60 is put into a halftone (gray) display state. Therefore, the transmission factor of the liquid crystal LC takes a value that is almost proportional to the applied voltage of the liquid crystal LC.

In contrast, in the present embodiment of the invention, two voltages only, which are an ON voltage and an OFF voltage, are used as voltages that are applied to the liquid crystal element 60 for tone display. Specifically, tone display according to the present embodiment of the invention is performed as follows; each frame is divided into a plurality of sub fields; time for applying an ON voltage or an OFF voltage to the liquid crystal element 60 is allocated while using the sub field as a unit of time. A potential signal C is supplied from the potential line driving circuit 400 to the potential line 30. The potential signal C is a binary signal. The potential of the potential signal C takes either a first voltage level V1 or a second voltage level V2. That is, the polarity of the potential signal C is reversed with the voltage level (i.e., potential) between the first voltage level V1 and the second voltage level V2 being taken as the center.

The potential line driving circuit 400 shown in FIG. 1 supplies the potential signals C1, C2, . . . , Cn to the n number of potential lines 30. The polarity of the potential signals C1, C2, . . . , Cn is reversed every frame. The timing of the polarity reversal of the potential signals C1, C2, . . . , Cn is staggered by 1H. The data potential DAT is a binary potential. Though it is not always necessary that the two values of the data potential DAT should coincide with the first voltage level V1 and the second voltage level V2, in this example, it is assumed for the purpose of simplifying a power source that the data potential DAT takes either the first voltage level V1 or the second voltage level V2.

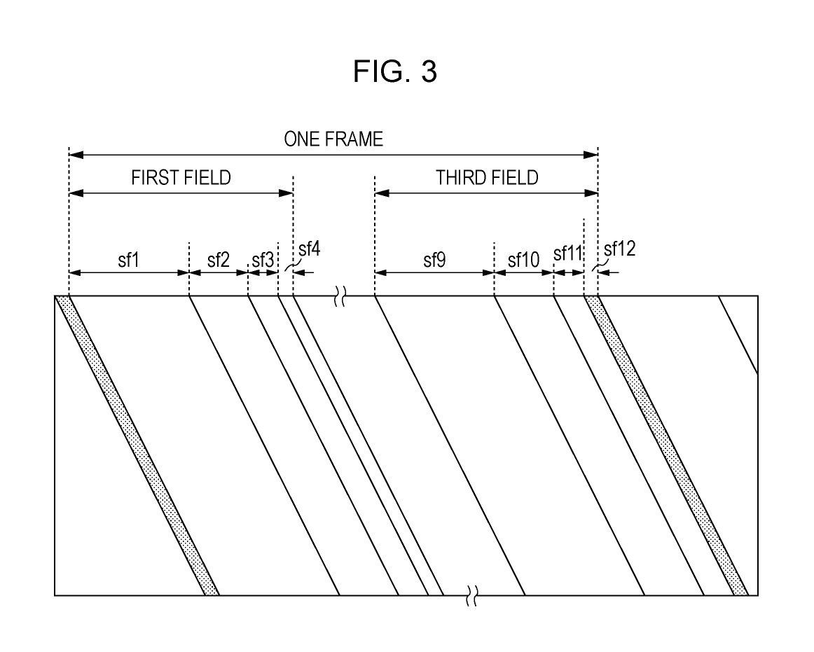

Next, sub-field driving that is adopted in the present embodiment of the invention is explained below. FIG. 3 is a diagram that schematically illustrates an example of sub fields according to an exemplary embodiment of the invention. In FIG. 3, one frame means a period of time that is required for forming one video unit (i.e., frame) of an image. In the present embodiment of the invention, a time period of one frame is made up of three field time periods. Each field time period is divided into four sub field time periods. This means that each frame is made up of twelve sub field time periods sf1, sf2, . . . , sf12. Each of the sub field time periods sf1 to sf11 is a time period that contributes to the display of an image, whereas the sub field time period sf12 is a time period that is allocated for reversing the polarity of a voltage that is applied to the liquid crystal element 60. Specifically, in the sub field time period sf12, a potential that is the same as the potential of the individual electrode 54 (the potential line 30) is sequentially written into the pixel electrode 53 as the data potential DAT (reset potential), followed by the reversing of the polarity of the potential signal C1, C2, . . . , Cn.

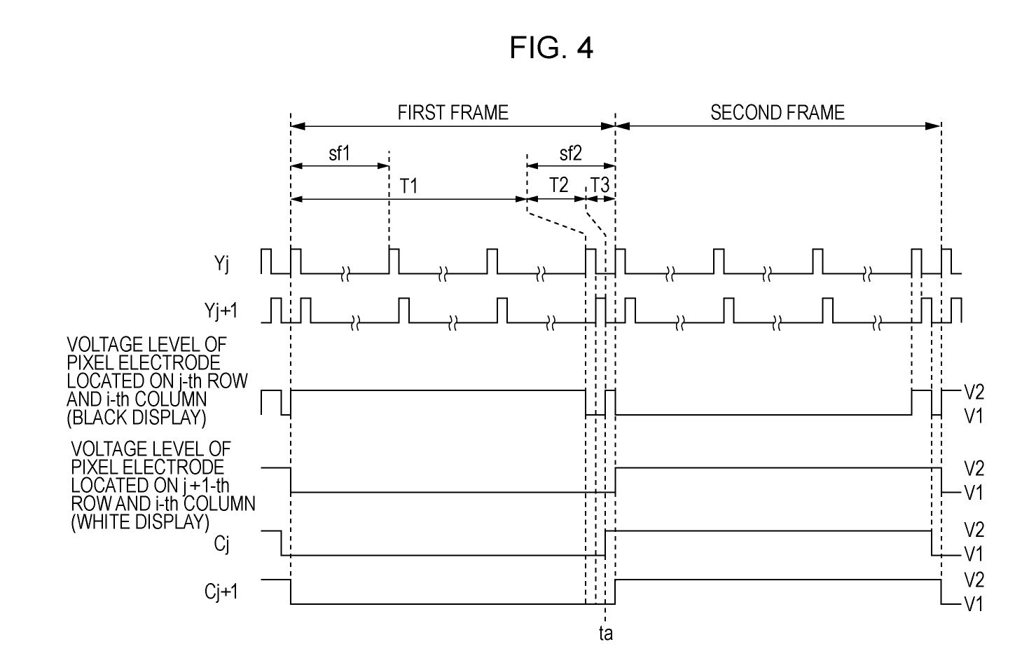

FIG. 4 is a diagram that schematically illustrates a relationship between scanning signals, potentials of pixel electrodes, and potential signals according to an exemplary embodiment of the invention. In FIG. 4, “j” denotes an arbitrary natural number that satisfies the mathematical condition of 1≦j≦n. In the same drawing, “i” denotes an arbitrary natural number that satisfies the mathematical condition of 1≦i≦m. As illustrated in FIG. 4, for the driving of the pixel 50, one frame is divided roughly into a first time period T1, a second time period T2, and a third time period T3. The first time period T1 corresponds to the sub field time periods sf1 to sf11. In the first time period T1, depending on tone that is to be displayed, either the first voltage level V1 or the second voltage level V2 is written into the pixel electrode that is located on the j-th row and the i-th column every sub field time period sf1 to sf11.

Since the liquid crystal element 60 according to the present embodiment of the invention operates in a normally white mode, the transmission factor of the liquid crystal element 60 decreases when a voltage is applied to the liquid crystal element 60. Therefore, it becomes black upon the application of a voltage thereto. The transmission factor of the liquid crystal element 60 increases when no voltage is applied to the liquid crystal element 60. Therefore, it becomes white when no voltage is applied thereto. In the illustrated example, the pixel that is located on the j-th row and the i-th column is in a black-display state in a first frame and a second frame. The pixel that is located on the j+1-th row and the i-th column is in a white-display state in the first frame and the second frame.

Next, in preparation for the reversing of the polarity of a potential signal Cj, driving operation for adjusting the potential of the pixel electrode 53 to make it equal to the potential of the individual electrode 54 is performed in the second time period T2. In the second time period T2, the potential signal Cj takes the first voltage level V1. Accordingly, the potential of the individual electrode 54 is the first voltage level V1. Therefore, in a time period in which the level of a scanning signal Yj is high, the first voltage level V1 is supplied as the data potential DAT so as to write the first voltage level V1 into the pixel electrode 53 that is located on the j-th row and the i-th column. As a result, the potential of the pixel electrode 53 becomes equal to the potential of the individual electrode 54.

Next, in the third time period T3, operation for reversing the polarity of the potential signal Cj is performed. In the illustrated example, a transition of the potential value of the potential signal Cj from the first voltage level V1 to the second voltage level V2 occurs at a point in time ta, which results in the reversal of polarity. Since the scanning signal Yj is not active in the third time period T3, the pixel electrode 53 that is located on the j-th row and the i-th column is in a floating state. For this reason, when a transition of the potential of the individual electrode 54 (potential signal Cj) from the first voltage level V1 to the second voltage level V2 occurs at the point in time ta, the potential of the pixel electrode 53 that is located on the j-th row and the i-th column is also raised due to liquid crystal capacitance. Therefore, a transition of the potential of the pixel electrode 53 on the j-th row and the i-th column from the first voltage level V1 to the second voltage level V2 also occurs. Therefore, when the second frame starts, a voltage level that is in accordance with (depends on) tone that is to be displayed is written into the pixel electrode 53 on the j-th row and the i-th column.

As explained above, in the present embodiment of the invention, an electrode that constitutes the counterpart of the pixel electrode 53 in an electrode pair is configured as the individual electrode 54. Control operation is performed to sequentially reverse the polarity of the potential line 30. After the completion of the polarity reversal, a voltage level that is in accordance with tone that is to be displayed is written into the pixel electrode 53 sequentially. The writing is performed on a row-by-row basis. For example, in a configuration in which the individual electrodes 54 are formed as a common counter electrode on a counter substrate throughout all of the pixels 50, when the polarity of the counter electrode potential is reversed, it is necessary to reverse the potential of the counter electrode after the writing of a potential that is the same as the potential of the counter electrode into all of the pixels 50. In contrast, in the present embodiment of the invention, since the potential of the n number of independent potential lines 30 is individually controlled with the use of the potential line driving circuit 400 instead of providing a counter electrode, it is not necessary to wait until the potential of the pixel electrodes 53 becomes equal to the potential of the individual electrodes 54 for all of the pixels 50. Therefore, it is possible to shorten the second time period T2 and the third time period T3 to increase the ratio of the first time period T1 to the second time period T2 and the third time period T3 in one frame. This makes it possible to perform display in greater tones. In addition, in the present embodiment of the invention, the reversal of polarity is performed on a potential-line-by-potential-line basis. Therefore, in comparison with a case where a counter electrode is used, it is possible to make the load of each single polarity reversal smaller. Generally, a large capacitance is generated on a counter electrode because the counter electrode is formed on the entire surface of a counter substrate. In contrast, since the potential lines 30 are independent of one another, capacitance is small. This is why it is possible to reduce the load of each single polarity reversal.

### 2. Variation Examples

The present invention is not limited to the exemplary embodiment described above. The invention can be modified in a variety of ways, several examples of which are described below.

(1) In the foregoing embodiment of the invention, it is explained that a horizontal electric field is applied to liquid crystal. However, the scope of the invention is not limited to such an example. Other operation scheme may be used as long as it is possible to drive potential lines independently. For example, it may be modified as follows; n number of potential lines are formed opposite to pixel electrodes on a counter substrate; in the same manner as done in the foregoing embodiment of the invention, the potential signals C1 to Cn for sequential polarity reversal are supplied to the n number of potential lines.

(2) In the foregoing embodiment of the invention, sub-field driving in which the binary data potential DAT that has two values of ON and OFF is written is taken as an example. However, the scope of the invention is not limited thereto. The invention can be applied to sub-field driving in which data potential DAT that has three or more values is written. Other driving scheme may be adopted as long as the potential of the pixel electrode 53 is made equal to the potential of the individual electrode 54 before the reversal of the polarity of the potential signal C.

(3) In the foregoing embodiment of the invention, sub-field driving in which one frame is divided into a plurality of sub field time periods with the writing of the binary data potential DAT is taken as an example. However, the scope of the invention is not limited thereto. The invention can be applied to analog driving in which a voltage level that is in accordance with tone is written into the pixel electrode 53 once in each frame. Specifically, it may be applied to the following scheme; in the first time period T1, a voltage level that is in accordance with tone that is to be displayed is written into each of the pixels 50 to be held therein by selecting the n number of scanning lines 10 sequentially; then, in the second time period T2, a potential that is the same as the potential of the individual electrode 54 is sequentially written for one row at a time; thereafter, in the third time period T3, the polarity of the potential lines 30 is reversed sequentially. As is the case with the foregoing example of sub-field driving, it is possible to control the potential of the individual electrode 54 on a row-by-row basis in this variation example. Therefore, it is possible to perform polarity reversal without any need to wait until the potential of the pixel electrodes 53 becomes equal to the potential of the individual electrodes 54 for all of the pixels 50.

(4) In the foregoing embodiment of the invention and examples of variation described herein, it is explained that the potential of the pixel electrode 53 is made equal to the potential of the individual electrode 54. However, it is not always necessary to make the potential of the pixel electrode 53 equal to the potential of the individual electrode 54. A reset potential that is written into the pixel electrode 53 may be set in such a way as to decrease a difference between the potential of the pixel electrode 53 and the potential of the individual electrode 54. When the reset potential is equal to the potential of the individual electrode 54 (the first voltage level or the second voltage level), the advantageous effects are greatest. However, as long as the potential difference is reduced, it is possible to lower the withstand voltage of the selection transistor 51 by the amount of reduction in the potential difference.

### 3. Electronic Apparatus

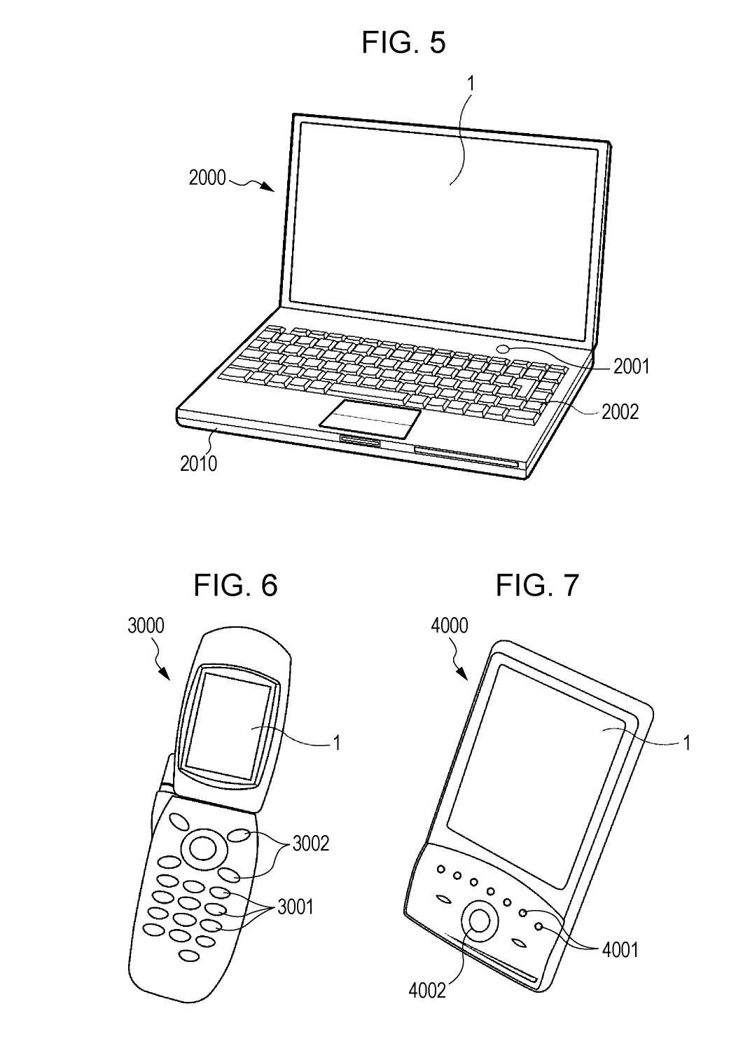

Next, an electronic apparatus to which the electro-optical device 1 according to the foregoing embodiment of the invention or the above variation examples is applied is explained below. FIG. 5 is a perspective view that schematically illustrates an example of the configuration of a mobile personal computer to which the electro-optical device 1 is applied. A personal computer 2000 includes the electro-optical device 1, which functions as its display unit, and a computer mainframe unit 2010. The computer mainframe unit 2010 is provided with a power switch 2001 and a keyboard 2002. FIG. 6 is a perspective view that schematically illustrates an example of the configuration of a mobile phone to which the electro-optical device 1 is applied. A mobile phone 3000 is provided with a plurality of manual operation buttons 3001, scroll buttons 3002, and the electro-optical device 1 functioning as its display unit. When a user operates the scroll buttons 3002, content displayed on the screen of the electro-optical device 1 is scrolled. FIG. 7 is a perspective view that schematically illustrates an example of the configuration of a personal digital assistant (PDA) to which the electro-optical device 1 is applied. A personal digital assistant 4000 is provided with a plurality of manual operation buttons 4001, a power switch 4002, and the electro-optical device 1 functioning as its display unit. When a user turns the power switch 4002 on and operates the manual operation buttons 4001, various kinds of information including but not limited to an address list and a schedule table are displayed on the electro-optical device 1. Among a variety of electronic apparatuses to which the electro-optical device 1 is applicable are, besides the above electronic apparatuses illustrated in FIGS. 5, 6, and 7, a projector, a head-mount display device, an electronic viewfinder, a digital still camera, a liquid crystal display TV, a car navigation device, an electronic personal organizer, an electronic calculator, a word processor, a workstation, a videophone, a POS terminal, a touch panel, and so forth. It is possible to embody the electro-optical device 1 explained above as a display device for such a variety of electronic apparatuses.

The invention can be applied, for example, industrially, to an electro-optical device, a method for driving the electro-optical device, and an electronic apparatus.

The entire disclosure of Japanese Patent Application No. 2009-156818, filed Jul. 1, 2009 is expressly incorporated by reference herein.

What is claimed is:

1. An electro-optical device comprising:
scanning lines;
data lines;
potential lines;
pixels corresponding to respective intersections of the scanning lines and the data lines, each of the pixels including:
a pixel electrode;
an electro-optical material that has optical characteristics that change depending on an electric field applied between the pixel electrode and the potential line; and
a switching element that is provided between the pixel electrode and the data line, the switching element being controlled in such a manner that the switching element is put into either an ON state or an OFF state, a scanning signal that is supplied through the scanning line is used for controlling the switching element; and
a driving section that operates in a cycle of unit periods of time, each of the unit periods of time including:
a first time period, wherein, in the first time period, the driving section supplies scanning signals for putting the switching elements into the ON state through the scanning lines in a predetermined sequential order and writes a data potential that is in accordance with an image that is to be displayed into the pixel electrode of each of the pixels through the data line;
a second time period, wherein, in the second time period, the driving section supplies scanning signals for putting the switching elements into the ON state through the scanning lines in a predetermined sequential order and writes, for one row at a time, a reset potential that makes a potential of the pixel electrode closer to, or makes a potential of the pixel electrode equal to, a potential of the potential line that extends on the row; and
a third time period, wherein, in the third time period, the driving section sequentially selects the potential lines to cause a transition of a potential that is supplied through the selected potential line from one of two potentials, which are a first potential and a second potential, to the other.

2. The electro-optical device according to claim 1, wherein the reset potential is the same as the potential of the potential line.

3. The electro-optical device according to claim 1, wherein the first time period is divided into a plurality of individual time periods; and the driving section supplies scanning signals for putting the switching elements into the ON state through the scanning lines in a predetermined sequential order and selects one of binary potential values as the data potential to write the selected potential into the pixel electrode of the pixel through the data line.

4. The electro-optical device according to claim 3, wherein the binary potential values are the first potential and the second potential.

5. The electro-optical device according to claim 1, wherein the pixel electrodes and the potential lines are formed on the same single substrate; and the electric field is a horizontal electric field.

6. An electronic apparatus that is provided with the electro-optical device according to claim 1.
